(19) United States
(12) Patent Application Publication
(10) Pub. No.: US 2011/0314419 A1
(43) Pub. Date: Dec. 22, 2011

(54) CUSTOMIZING A SEARCH EXPERIENCE USING IMAGES

(75) Inventors: MELISSA W. DUNN, WOODINVILLE, WA (US); DANIEL SALVATORE SCHIAPPA, BELLEVUE, WA (US); SHANKAR VAIDYANATHAN, SAMMAMISH, WA (US)

(73) Assignee: MICROSOFT CORPORATION, REDMOND, WA (US)

(21) Appl. No.: 12/820,895

(22) Filed: Jun. 22, 2010

(51) Int. Cl. G06F 17/30; G06F 3/048

(52) U.S. Cl. 715/810; 707/769; 707/E17.014

(57) ABSTRACT

Systems, methods, and computer storage media having computer-executable instructions embodied thereon that present images customized for a user. In embodiments, a search query input by a user and user data associated with the user are referenced. The search query and/or user data is utilized to select one or more images to display via a display screen. Such an image(s) can be, for example, a background image that is presented as a background to a search results webpage and/or an icon image that represents a category of search results.

### BACKGROUND

In response to user queries, search results are oftentimes presented in the form of captions including a title, a URL, and a snippet. In this regard, a search results page can be cluttered with a large amount of content. The amount of content that fills the viewing space of a mobile device is even more restricted. In addition, search query suggestions displayed over the background or search results, although potentially beneficial to a user, can occupy too much viewing area of the display screen. A display screen cluttered with content (e.g., text, search query suggestions, etc.) can be overwhelming and uninteresting to a user. As a result, a dissatisfied user might exit the search experience prior to obtaining desired information. Accordingly, it is important that the content that occupies the viewing space captures the user's attention, particularly with mobile devices due to the limited size of the display screen.

### SUMMARY

Embodiments of the present invention relate to systems, methods, and computer-readable media for, among other things, customizing a search experience using images. In this regard, embodiments of the present invention utilize a search query entered by a user and/or user data associated with a user to select an image(s) to display in association with a search results webpage. Such an image might be a background image displayed as the background of a search results webpage or an icon image that represents a category of search results. A background image corresponding with the search query and/or user data may be of interest to the user and capture the user's attention. An icon image related to the search query and/or user data can be interesting to the user and simplify or organize the content provided to the user in connection with a search experience.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

The present invention is described in detail below with reference to the attached drawing figures, wherein:

FIG. 1 is a block diagram of an exemplary computing environment suitable for use in implementing embodiments of the present invention;

FIG. 2 is a block diagram of an exemplary computing system architecture suitable for use in implementing embodiments of the present invention;

FIG. 3 is an exemplary screen display showing a background image and icon images, in accordance with one embodiment of the present invention;

FIG. 4 is an exemplary screen display showing a display of information presented upon selection of an icon image, in accordance with one embodiment of the present invention;

FIG. 5 is a flow diagram showing a method for presenting one or more background images customized for a user, in accordance with an embodiment of the present invention;

FIG. 6 is a flow diagram showing a method for presenting one or more icon images customized for a user, in accordance with an embodiment of the present invention; and

FIG. 7 is a flow diagram showing a method for presenting a suggested-query selector to view suggested search queries, in accordance with an embodiment of the present invention.

### DETAILED DESCRIPTION

The subject matter of the present invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

Embodiments of the present invention relate to systems, methods, and computer storage media having computer-executable instructions embodied thereon that customize a search experience using images. In this regard, embodiments of the present invention provide images, such as background images and/or icon images, that are dynamically customized for a user based on a search query and/or user data associated with the user. Accordingly, a user search experience can provide background images that are relevant and interesting to the user. Additionally or alternatively, icon images that represent categories of search results can be provided to simplify and organize a user search experience. Such images can engage a user to enhance the user search experience.

Accordingly, in one aspect, the present invention is directed to one or more computer storage media having computer-executable instructions embodied thereon, that when executed, cause a computing device to perform a method for presenting one or more background images customized for a user. The method includes referencing a search query input by a user. The method further includes referencing one or more user data in association with the user. The search query and the user data in association with the user are utilized to select an image to display as a background image of a search results webpage. The selected image is displayed as a background of the search results webpage.

In another aspect, the present invention is directed to a method for presenting icon images customized for a user. The method includes referencing a search query input by a user. The method further includes referencing user data in association with the user. Icon images to be displayed are identified based on the search query and the user data in association with the user. The icon images represent a category of search results and are displayed within a search results webpage. Selection of an icon image results in display of one or more search results, or information in association therewith, that correspond with the category of search results represented by the selected icon image.

In yet another aspect, the present invention is directed to a system for customizing a search experience for a user. The system includes a computing device associated with one or more processors and one or more computer-readable storage media, a data store coupled with the computing device, and an image selecting engine. The image selecting engine receives a search query input by a user, user profile data that indicates at least one interest of the user, and device data in association with the computing device being used by the user. Further, the image selecting engine uses the search query, the user profile data, and the device data to identify a background image to be displayed as a background of a search results webpage and identify icon images to be displayed on the search results webpage. The icon images represent categories of search results. The image selecting engine outputs the background image and the one or more icon images for presentation.

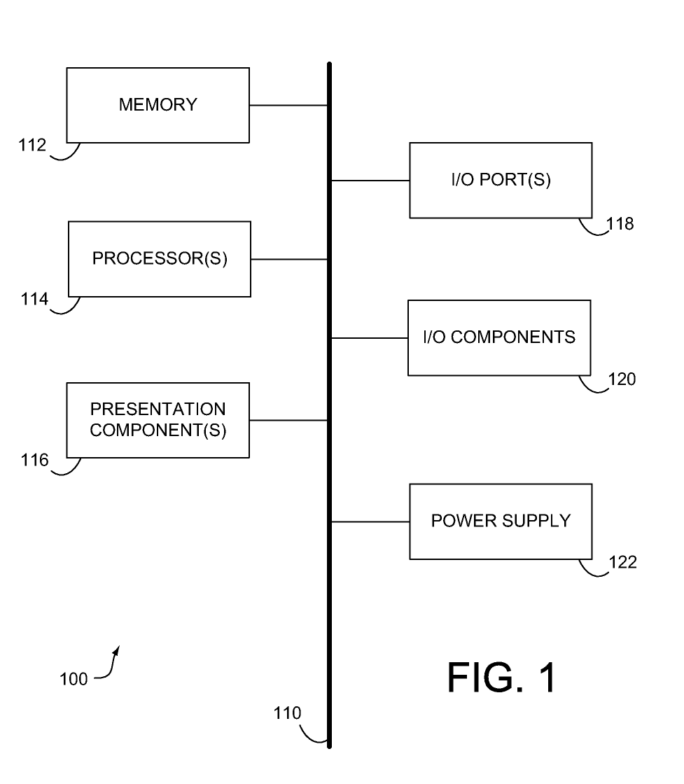

Having briefly described an overview of the present invention, an exemplary operating environment in which various aspects of the present invention may be implemented is described below in order to provide a general context for various aspects of the present invention. Referring to the drawings in general, and initially to FIG. 1 in particular, an exemplary operating environment for implementing embodiments of the present invention is shown and designated generally as computing device 100. Computing device 100 is but one example of a suitable computing environment and is not intended to suggest any limitation as to the scope of use or functionality of the invention. Neither should the computing device 100 be interpreted as having any dependency or requirement relating to any one or combination of components illustrated.

Embodiments of the invention may be described in the general context of computer code or machine-useable instructions, including computer-executable instructions such as program modules, being executed by a computer or other machine, such as a personal data assistant or other handheld device. Generally, program modules including routines, programs, objects, components, data structures, etc., refer to code that perform particular tasks or implement particular abstract data types. Embodiments of the invention may be practiced in a variety of system configurations, including hand-held devices, consumer electronics, general-purpose computers, more specialty computing devices, etc. Embodiments of the invention may also be practiced in distributed computing environments where tasks are performed by remote-processing devices that are linked through a communications network.

With reference to FIG. 1, computing device 100 includes a bus 110 that directly or indirectly couples the following devices: memory 112, one or more processors 114, one or more presentation components 116, input/output ports 118, input/output components 120, and an illustrative power supply 122. Bus 110 represents what may be one or more busses (such as an address bus, data bus, or combination thereof). Although the various blocks of FIG. 1 are shown with lines for the sake of clarity, in reality, delineating various components is not so clear, and metaphorically, the lines would more accurately be grey and fuzzy. For example, one may consider a presentation component such as a display device to be an I/O component. Additionally, many processors have memory. The inventors hereof recognize that such is the nature of the art, and reiterate that the diagram of FIG. 1 is merely illustrative of an exemplary computing device that can be used in connection with one or more embodiments of the present invention. Distinction is not made between such categories as “workstation,” “server,” “laptop,” “hand-held device,” etc., as all are contemplated within the scope of FIG. 1 and reference to “computing device.”

The computing device 100 typically includes a variety of computer-readable media. Computer-readable media can be any available media that can be accessed by the computing device 100 and includes both volatile and nonvolatile media, removable and non-removable media implemented in any method or technology for storage of information such as computer-readable instructions, data structures, program modules or other data. Computer-readable media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by the computing device 100. Combinations of any of the above should also be included within the scope of computer-readable media.

Memory 112 includes computer-storage media in the form of volatile and/or nonvolatile memory. The memory may be removable, nonremovable, or a combination thereof. Exemplary hardware devices include solid-state memory, hard drives, optical-disc drives, etc. Computing device 100 includes one or more processors that read data from various entities such as memory 112 or I/O components 120. Presentation component(s) 116 present data indications to a user or other device. Exemplary presentation components include a display device, speaker, printing component, vibrating component, etc.

I/O ports 118 allow computing device 100 to be logically coupled to other devices including I/O components 120, some of which may be built in. Illustrative components include a microphone, joystick, game pad, satellite dish, scanner, printer, wireless device, etc.

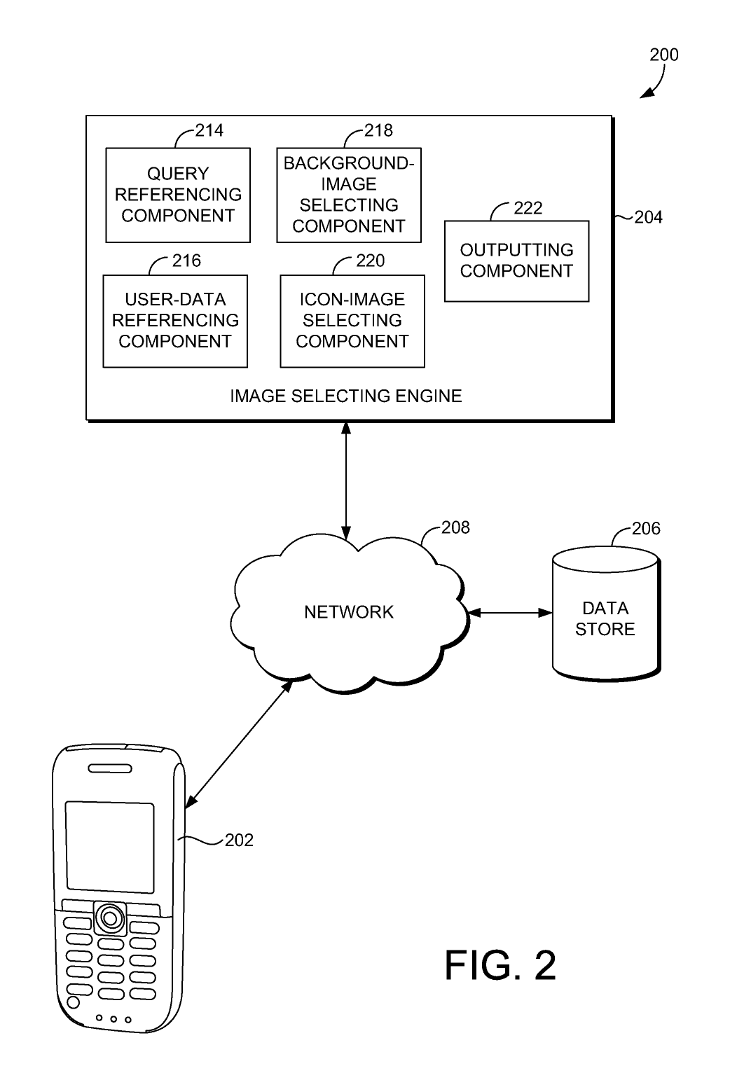

With reference to FIG. 2, a block diagram is illustrated that shows an exemplary computing system architecture 200 configured for use in implementing embodiments of the present invention. It will be understood and appreciated by those of ordinary skill in the art that the computing system architecture 200 shown in FIG. 2 is merely an example of one suitable computing system and is not intended to suggest any limitation as to the scope of use or functionality of the present invention. Neither should the computing system architecture 200 be interpreted as having any dependency or requirement related to any single module/component or combination of modules/components illustrated therein.

Computing system architecture 200 includes a computing device 202 (illustrated in FIG. 2 as a mobile computing device), an image selection engine 204, and a data store 206, all in communication with one another via a network 208. The network 208 may include, without limitation, one or more local area networks (LANs) and/or wide area networks (WANs). Such networking environments are commonplace in offices, enterprise-wide computer networks, intranets and the Internet. Accordingly, the network 208 is not further described herein.

In some embodiments, one or more of the illustrated components/modules may be implemented as stand-alone applications. In other embodiments, one or more of the illustrated components/modules may be integrated directly into the operating system of the image selection engine 204 and/or the end-user computing device 202. It will be understood by those of ordinary skill in the art that the components/modules illustrated in FIG. 1 are exemplary in nature and in number and should not be construed as limiting. Any number of components/modules may be employed to achieve the desired functionality within the scope of embodiments hereof. Further, components/modules may be located on any number of servers or client computing devices. By way of example only, the image selection engine 204 might reside on a server, cluster of servers, or a computing device remote from one or more of the remaining components.

It should be understood that this and other arrangements described herein are set forth only as examples. Other arrangements and elements (e.g., machines, interfaces, functions, orders, and groupings of functions, etc.) can be used in addition to or instead of those shown, and some elements may be omitted altogether. Further, many of the elements described herein are functional entities that may be implemented as discrete or distributed components or in conjunction with other components/modules, and in any suitable combination and location. Various functions described herein as being performed by one or more entities may be carried out by hardware, firmware, and/or software. For instance, various functions may be carried out by a processor executing instructions stored in memory.

The data store 206 is configured to store information associated with images, user queries, and user data. In various embodiments, such information may include, without limitation, images, image attributes, user profile data, device data, and/or the like. In embodiments, the data store 206 is configured to be searchable for one or more of the items stored in association therewith. It will be understood and appreciated by those of ordinary skill in the art that the information stored in association with the data store 206 may be configurable and may include any information relevant to one or more images, user queries, user data, and/or the like. The content and volume of such information are not intended to limit the scope of embodiments of the present invention in any way. Further, though illustrated as a single, independent component, the data store 206 may, in fact, be a plurality of storage devices, for instance a database cluster, portions of which may reside on the image selection engine 204, the computing device 202, another external computing device (not shown), and/or any combination thereof.

Each of the computing device 202 and the image selection engine 204 shown in FIG. 2 may be any type of computing device, such as, for example, computing device 100 described above with reference to FIG. 1. By way of example only and not limitation, each of the computing device 202 and the image selection engine 204 may be a personal computer, desktop computer, laptop computer, handheld device, mobile handset, consumer electronic device, server, or the like. It should be noted, however, that embodiments are not limited to implementation on such computing devices, but may be implemented on any of a variety of different types of computing devices within the scope of embodiments hereof.

Components of the computing device 202 and the image selection engine 204 (not shown for clarity) may include, without limitation, a processing unit, internal system memory, and a suitable system bus for coupling various system components, including one or more databases for storing information (e.g., files and metadata associated therewith). Each of the computing device 202 and the image selection engine 204 typically includes, or has access to, a variety of computer-readable media. By way of example, and not limitation, computer-readable media may include computer-storage media and/or communication media. In general, communication media enables each server to exchange data via a network, e.g., network 208. More specifically, communication media may embody computer-readable instructions, data structures, program modules, or other data in a modulated data signal, such as a carrier wave or other transport mechanism, and may include any information-delivery media. As used herein, the term “modulated data signal” refers to a signal that has one or more of its attributes set or changed in such a manner as to encode information in the signal. By way of example, and not limitation, communication media includes wired media such as a wired network or direct-wired connection, and wireless media such as acoustic, RF, infrared, and other wireless media. Combinations of any of the above also may be included within the scope of computer-readable media.

It will be understood by those of ordinary skill in the art that computing system architecture 200 is merely exemplary. While the image selection engine 204 is illustrated as a single unit, one skilled in the art will appreciate that the image selection engine 204 is scalable. For example, the image selection engine 204 may in actuality include a plurality of computing devices in communication with one another. Moreover, the data store 206, or portions thereof, may be included within the computing device 202 and/or the image selection engine 204 as a computer-storage medium. The single unit depictions are meant for clarity, not to limit the scope of embodiments in any form.

The computing device 202 shown in FIG. 2 is a mobile computing device, such as a mobile telephone. It will be understood by those of ordinary skill in the art that the mobile computing device 202 is merely exemplary and that the computing device 202 may be any type of computing and/or communication device, such as a personal computer, a textual communication device, a television (IPTV), a desktop, or the like. The computing device 202 includes a user input module and a presentation module.

The user input module is configured for receiving input. Such input might include, for example, user search queries. Typically, input is input via a keyboard or keypad (hard or virtual such as a touchscreen keypad) associated with the computing device 202, or the like. Other hardware selectors (e.g., hard buttons) or software selectors (e.g., virtual selector or button) associated with the computing device 202 can be used to input data or selections. For example, as discussed more fully below, a suggested-query selector can be presented on the display screen that, when selected or contacted, triggers an indication to a query search engine (not shown) that query suggestions are desired. The presentation module of the computing device is configured for presenting content, such as background images, icon images, etc. in association with search results webpages. Embodiments are not intended to be limited to visual display but rather may also include audio presentation, combined audio/video presentation, and the like.

As shown in FIG. 2, the image selecting engine 204 includes, among other components, includes a query referencing component 214, a user-data referencing component 216, a background-image selecting component 218, an icon-image selecting component 220, and an outputting component 222. The query referencing component 214 is configured to reference one or more search queries, or portions thereof (e.g., search terms or search phrases). The query referencing component 214 might receive, retrieve, obtain, access, or intercept a search query, or a portion thereof, entered by a user into a search engine via a search engine webpage or client. Such a search engine might be any information retrieval system used to locate information within a computer system (e.g., the World Wide Web or other computer system) and provide search results. As such, in one embodiment, a search engine might be a web search engine that may search the World Wide Web generally based on a user's search query. Such a web search engine may provide search results related to any variety of products, services, information, data, or other information available on the World Wide Web. In this regard, a web search engine provides search results via a search engine webpage or client that are based generally on the user search query. For example, based on a user search query input into a general search website (e.g., Microsoft's Live.com), a general search engine (Microsoft® Live Search) searches for and provides general search results related to the search query.

One skilled in the art will appreciate that a user can interact with a search engine in any variety of ways. A user might interact with a search engine in a webpage format. That is, a search engine webpage might be utilized to enter a search query (e.g., via an initial search webpage) and provide search results (e.g., via a search results webpage). Exemplary search engine and corresponding webpages include, but are not limited to, Microsoft® Live Search accessible via Microsoft's Live.com and MSN.com web portal, Google™ search accessible through Google's google.com web portal, and Yahoo! search accessible through Yahoo's yahoo.com web portal. Alternatively, a user might interact with a search engine in a toolbar format in which a search query entry field is placed on a user's web browser for easier access to the search engine.

The user-data referencing component 216 is configured to reference one or more user data. The user-data referencing component 216 might receive, retrieve, obtain, access, intercept, etc., one or more user data. User data, as used herein, refers to any data in association with a user of a search engine and/or a device being used by the user to access the search engine, such as the computing device 202. User data includes, for example, user profile data, device data, related data, global data, and/or the like. User profile data is any data or indicator in association with a user including, for example, habitual or routine behaviors of the user and/or indicators associated with events, activities or behaviors of the user. User profile data may include, by way of example only, routine search behaviors of the user, searches or queries previously provided by the user, text and/or email conversations engaged in by the user, events scheduled on the user's electronic calendar, multimedia events engaged in by the user (such as listening to music, watching television programming, etc.), links to uniform resource locators (URLs) frequented by the user, keywords extracted from text and/or email conversations engaged in by the user, and/or the like. As such, user profile data might be data that is identified or captured in association with the search engine. Alternatively or additionally, user profile data might be data that is identified or captured in association with user interaction of the web browser, the client, and/or the computing device of the user. User profile data may also include user information input and/or modified directly by the user (e.g., user interests, birthday, etc.). In some embodiments, user profile data can be captured or identified in association with a user identifier (e.g., a user identifier used by the user to log in) or a user device, such as computing device 202.

Device data refers to any data in association with the computing device, such as computing device 202, being used by the user. Device data might include an indication of whether the device is touched enabled, a screen size of the device, a device identifier, an indication of available bandwidth for transferring data (e.g., a particular service provider supports a particular amount of bits per second), or the like.

Relational data refers to data in association with another user related to the current user of the search engine. In this regard, relational data can provide information regarding content another related user desired or intended to view. A user might be related to another user based on a contact with a user (e.g., via electronic mail, electronic calendar, address book, instant message, social networking, etc.). In another embodiment, a user might be related to another user based on similar interests. Such similar interests shared by users can be determined, for example, based on queries entered or searches performed by users.

Global data refers to data generally associated with one or more users of a search engine. For example, global data might refer to a popular, most frequently used, or preferred data or image.

The background-image selecting component 218 is configured to select one or more background images. In this regard, a background image(s) is selected to be displayed as a background of a search results page that generally presents one or more search results associated with a search query. An image, as used herein, refers to any image including, but not limited to, a photograph, a graphic, a video, an animated image, etc. As can be appreciated, an image might be a still image (i.e., computer graphic, photograph, etc.) or a moving image (i.e., video, movie, etc.). A background image is used to refer to an image presented as a background of a search results page on which one or more search results, or indications thereof (e.g., icon images) are presented. Such a background image(s) enables a user to initially engage in the search experience. Although generally discussed herein as a background of a search results page, as can be appreciated such an image could be a background of an initial search engine page (e.g., prior to a user inputting or entering a user query). In such a case, the background image might be selected based solely on user data. In some cases, a background image might be an advertisement. In such a case, an advertisement engine might be utilized to select or assist in selecting an advertisement to display as a background image.

In embodiments, the background-image selecting component 218 utilizes query data, such as one or more queries referenced by the query referencing component 214, and/or user data, such as one or more user data referenced by the user-data referencing component 216, to identify or select one or more background images. In this regard, a user query is used to select an image that is related to the search query. User data is used to select an image that is suitable for the user and/or user device. Accordingly, user profile data can be used to select an image that matches or corresponds with the users interests. By way of example only, assume that a user enters a query of “Iron Man 2.” Further assume that user profile data of the user indicates that the user habitually searches for music. In such a case, the image of the music album cover in association with “Iron Man 2” can be selected and displayed.

Device data can be used to select an image that is appropriate with regard to capabilities and functionality of the computing device being used by the user. In this regard, images attributes, such as quality of images, sizes of images, may be considered in association with device data to select an appropriate set of one or more images. Relational data can be used to select an image that corresponds with assumed or deducted interests of the user, that is, interests of one or more other users that are related to the present user of the search engine. Global data can be used to select an image that is generally of interest to one or more other users of the search engine.

In addition to selecting one or more images for display, the background-image selecting component 216 can also select a number of images to be displayed as a background. In one embodiment, multiple images can be simultaneously displayed as a unified or dispersed background image. In an alternative embodiment, multiple images can be displayed subsequently. Accordingly, one image or group of images might be displayed as a background image and, subsequently, another image or group of images might be displayed as the background. By way of example only, a subsequent image might be displayed based on an occurrence of an event (e.g., lapse of time, etc.) or based on a user indication (e.g., user selects a background selector, etc.). A number of images to display might be based on device data, such as capabilities of the computing device, or user data, such as preferences of the user (e.g., three images correspond with the user interests, two images is set in a user profile, etc.). In further embodiments, a background image might be modified in response to a user selecting an icon image. In such embodiments, upon a user selection of an icon image, a background image can be selected and/or displayed that corresponds with the icon image. For instance, if a “music” icon image is selected by a user, the background image might be changed to be the image of the album cover.

The icon-image selecting component 220 is configured to select one or more icon images. An icon image refers to an image that is an icon representing a category of search results. This allows a search results page to be intuitive and uncluttered. Icon images might represent various categories, such as, for example, images, videos, movies, news, calendar, related locations, shopping or merchandise, music, etc. A music icon might present, upon selection thereof, for example, tracks, artists, downloads, locations (e.g., virtual locations, physical nearby locations) at which to purchase music, etc. A merchandise icon might present, upon selection thereof, merchandise related to the search query and/or user data. A movie icon might present, upon selection thereof, nearby theatres showing the movie, movie purchase tickets options, directions to a nearby theatre, etc. A calendar icon might present, upon selection thereof, information in a user's electronic calendar, an option to create a calendar event, an option to share/invite others, etc. A news icon might present, upon selection thereof, news information in association with the search query and/or user interests. A video icon might present, upon selection thereof, videos, trailers, consumer content, etc. in relation to the search query, similar user queries, user data, etc. An image icon might present, upon selection thereof, images in relation to the search query, similar user queries, user data, etc. Additionally or alternatively, an image icon represents data related to search results, such as instant answers or information presented as a result of performing a task.

In embodiments, the icon-image selecting component 220 utilizes query data, such as one or more queries referenced by the query referencing component 214, and/or user data, such as one or more user data referenced by the user-data referencing component 216, to identify or select one or more icon images. In this regard, a user search query is used to select one or more icon image that is related, appropriate, or suitable to the search query. Icon images can be predetermined (e.g., stored within the data store) or dynamically determined based on appropriateness to the search query.

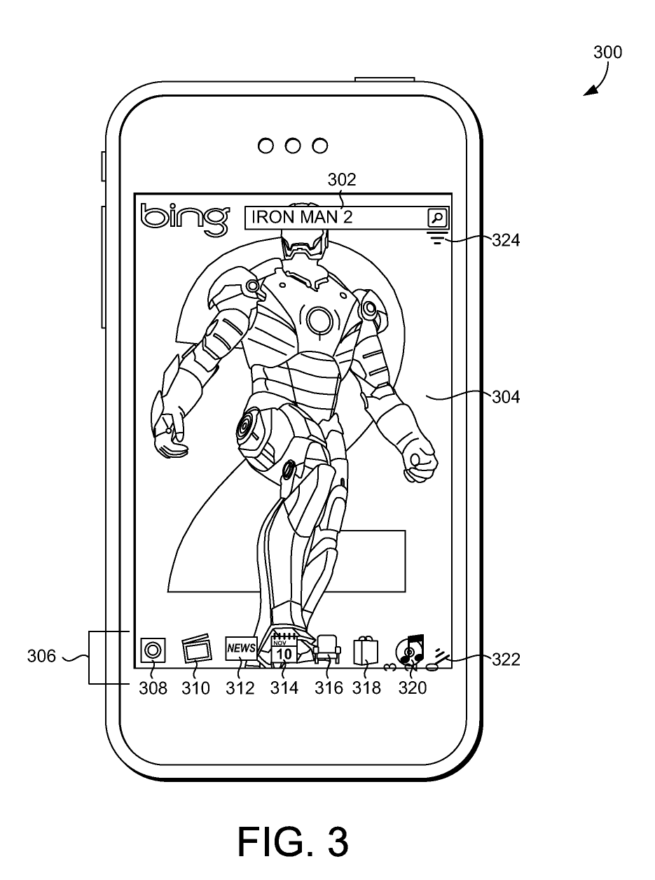

By way of example and with reference to FIG. 3, assume that a user enters the search query “iron man 2” as illustrated at 302. In this regard, upon referencing the search query “iron man 2,” the icon images that correspond with and are appropriate for the search query are identified and selected in accordance with the search query. Because the search query and/or search results related to the categories of images 308, videos 310, news 312, electronic calendar 314, theater location 316, merchandise 318, and music 320 exist, icon images representing such categories are appropriate selected and displayed. In some cases, if numerous search result categories are available and appropriate, particular icons might be selected such that a predetermined number of icon images displayed is not exceeded. Selection of icon images might be based on, for example, popularity, number of corresponding search results, etc. As can be appreciated, icon images representing search result categories can initially be solely displayed on a search results webpage or in addition to other search results being displayed (e.g., top search results, search results that do not correspond with a selected category, particular types of search results, such as images, etc.).

Prior to or subsequent to selecting one or more icon images for display, search results or tasks available to perform can be associated with one or more icon images. In instances that search results are associated with icon images prior to selecting icon images to display, the search results, or quantity thereof, in association with particular categories might be used to select one or more icon images for display. For example, assume that a plethora of “news” search results is associated with a search query input by a user, such information may assist in selecting a “news” image icon for display. In instances that search results are associated with icon images after selecting icon images to display, such a categorization enables the user to select an icon image to view search results related to such a category (as identified/represented by the icon image).

Additionally or alternatively, user data can be used to select one or more icon images. Accordingly, user profile data can be used to select an image that aligns or corresponds with the users interests. Device data can be used to select an image that is appropriate with regard to capabilities and functionality of the computing device being used by the user. Relational data can be used to select an image that corresponds with suspected interests of the user, that is, interests of other users that are related to the user currently using performing a search. Global data can be used to select an image that is generally of interest to the other users of the search engine. By way of example only, and with reference again to FIG. 3, assume that a user enters the search query “iron man 2” as indicated at 302. Further assume that, historically, the user has expressed an interest (e.g., via previous search experiences) in going to movies at the theater. In such a case, a “related location” icon that, when selected, presents nearby theaters showing the movie might be selected for display. A user can select the “related location” icon to view nearby theatres showing the movie, purchase tickets for a theatre, get directions to the theatre, etc.

The icon-image selecting component 220 can also be configured to select a number of icon images to be displayed in association with search results. By way of example only, a number of search results corresponding with a category, user profile data, device data, relational data, global data, etc., can be used to determine a number of icon images to display. In one embodiment, multiple icon images can be simultaneously displayed. In an alternative embodiment, multiple icon images can be displayed subsequently. By way of example only, a subsequent icon image might be displayed based on an occurrence of an event (e.g., lapse of time, etc.) or based on a user indication (e.g., user selects a next image indicator, etc.). A number of images to display might be based on device data, such as capabilities of the computing device, or user data, such as preferences of the user (e.g., three icon images correspond with the user interests, two icon images is set in a user profile, etc.).

Query data, such as one or more queries referenced by the query referencing component 214, and/or user data, such as one or more user data referenced by the user-data referencing component 216, can also be used to select an order or arrangement in which to present one or more selected icon images. For example, a more popular category, such as a category more related to the user query, more related to an interest(s) of the user, more globally popular, etc. can be placed in the center or mid-point of the image icons displayed, displayed on a larger scale, displayed on a first page of results, or the like. For instance, assume that user data in association with a user indicates that the user is interested in comics. In such a case, a comic icon image might be selected and displayed in the center of the display screen.

The outputting component 222 is configured for causing presentation of images in association with the computing device of the user. For instance, the output component 220 is configured for causing presentation of one or more selected background images in association with the display screen 120 of the mobile computing device 110 of FIG. 1. In another example, the output component 220 is configured for causing presentation of one or more selected icon images in association with the display screen 120 of the mobile computing device 110 of FIG. 1. While images are described as being provided and presented, it is straightforward for the system 100 to provide a link or other reference by which the user device may retrieve the relevant images. Note that the link need not be followed by a conventional browser; for example, an application that outputs contacts or a call history list can follow the link, obtain the image(s) and insert a representation of the image(s) into its output. Any and all such variations, and any combination thereof, are contemplated to be within the scope of embodiments of the present invention.

As previously discussed, a computing device displays images in the context of a search results page. As shown in FIG. 3, a background image 304 in association with a user query and/or user data is displayed as the background for the search results. As can be appreciated, in some embodiments, a background image(s) might be displayed upon a user entering a user query. In alternative embodiments, a background image might be displayed as a user inputs a search query.

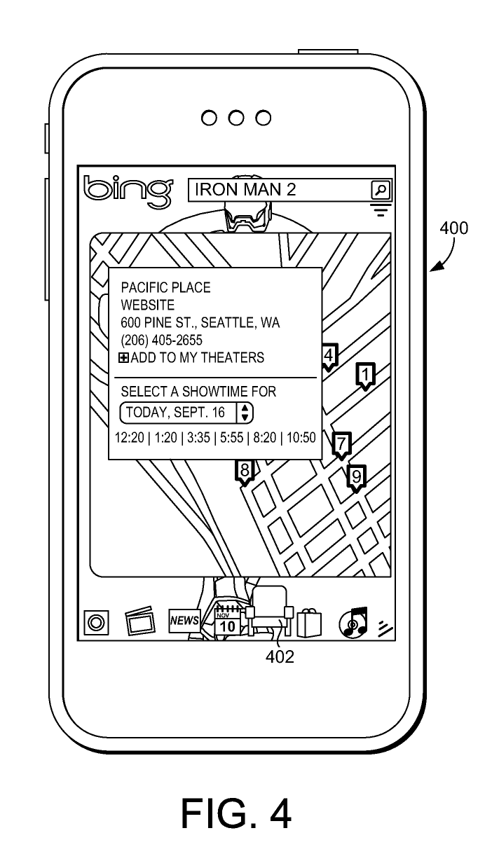

Similarly, as shown in FIG. 3, a set of one or more icon images 306 that represent categories of search results are displayed within a search results page. In embodiments, such icon images are selected based on the user query and/or user data. In FIG. 3, such icon images include an images icon 308, a videos icon 310, a news icon 312, a calendar icon 314, a location icon 316, a merchandise icon 318, and a music icon 320. Although particular icon images 308-320 are shown in FIG. 3, as can be appreciated, any number or types of icon images can be displayed in various embodiments. Selecting such icons results in a display of information relevant to the search query and corresponding with the category represented by the image icon. In this regard, selecting an icon image can result in search results, or information in association therewith (e.g., instant answers), being displayed. By way of example only, assume that a user selects the location icon 316 of FIG. 3. In such a case, nearby theaters at which the user can view the movie are displayed, as illustrated in display screen 400 of FIG. 4. Such a display screen 400 may include, for example, information pertaining to the theater including, but not limited to, location, phone number, hours, current movies, show times, link to website, menus, etc. In this regard, selecting an icon image can result in a display of search results related to the icon image. Alternatively or additionally, selecting an icon image can result in performance of a task, the result of which is displayed. For instance, rather than displaying search results, upon selecting an icon image, performance of a task or application can be initiated, such as, providing instant answers that relate to the user query, identifying stores for purchasing merchandise (physical stores or virtual stores), generating a map, or performance of other tasks related to the search query or search results in association therewith.

Further, as illustrated in FIG. 4, the selected location icon 402 may appear larger and/or brighter to indicate that such an icon is currently selected. Although illustrated in FIG. 4 as a larger icon, upon selecting an icon image, such an icon image can be modified in any manner to provide an indication that the particular icon is the currently selected icon or most recently selected icon. Alternatively to modifying the icon image, another indicator can be provided in association with the icon image to provide such an indication (e.g., a highlight or symbol can be placed around or near the icon image).

In some embodiments, various selectors can be used. A selector, as used herein, can be presented on the display screen such that, when selected or contacted, an indication that performance of a particular function is desired. A selector can be used so that the display screen is not cluttered with various display items. A selector also allows a user to quickly and easily view more related items (e.g., suggested queries, background images, icon images, etc.). Accordingly, a selector, when selected, triggers an indication that more related items are desired. While shown in FIG. 1 as a software selector, more indicators may be a hardware selector, or a combination thereof. A selector can be selected by a user by way of a touchscreen, hovering over the selector via a mouse or pointer, selecting the selector via a mouse, pointer, or commands, etc.

Selectors may be, for example, an icon selector, a suggested-query selector, a background selector, and the like. An icon selector, as shown at 322 of FIG. 3, can be selected to display more icon images. Accordingly, upon selection of the icon selector 322, a complete new set of one or more icon images might be displayed to replace one or more of the currently displayed icon images or to add to the currently displayed icon images. A suggested-query selector, as shown at 324 of FIG. 3, can be selected to display alternative search query suggestions. In embodiments, such query suggestions can be based on the user query and/or user data. In this regard, the query suggestions can be provided based on interests of the user as identified from, for example, prior search routines. Although not illustrated, as can be appreciated, a background selector can also be associated with the background image such that, upon selection, an alternative background image(s) is displayed as a background for the search results. Such an alternative background image(s) can be displayed either simultaneously with the currently presented background image or subsequent to a currently presented background image. Although selectors are shown in FIG. 3 as having a particular design and location, such design and location are not intended to limit the scope of selectors.

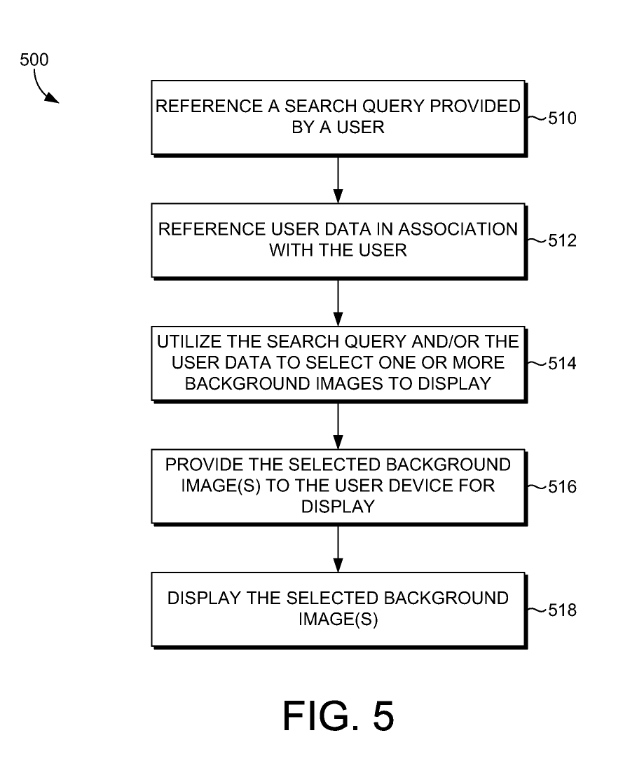

Turning now to FIG. 5, a flow diagram is illustrated which shows a method 500 for presenting one or more background images customized for a user, in accordance with an embodiment of the present invention. Initially, at block 510, a search query provided by a user is referenced. For example, a search query entered by a user of a mobile computing device may be referenced. At block 512, user data in association with the user is referenced. Subsequently, at block 514, the search query and/or the user data are used to select one or more background images to display. In embodiments, such a background image(s) corresponds with and is suitable for display to the user as a background image of the search results page. In this regard, the selected background image can be related to the query entered by the user and to historical interests of the user. At block 516, the selected images, or representations thereof, are provided to the user device for display. At block 518, the selected background image(s) are displayed via a display screen of the user device. In embodiments, the background image is displayed in association with search results or icon images representing categories of search results. As can be appreciated, various items, such as search results or icon images representing such results, can be displayed over the background image. In this regard, the background image and/or the search results/icon images may be at least partially transparent to enable viewing of both the background image and the search results/icon images.

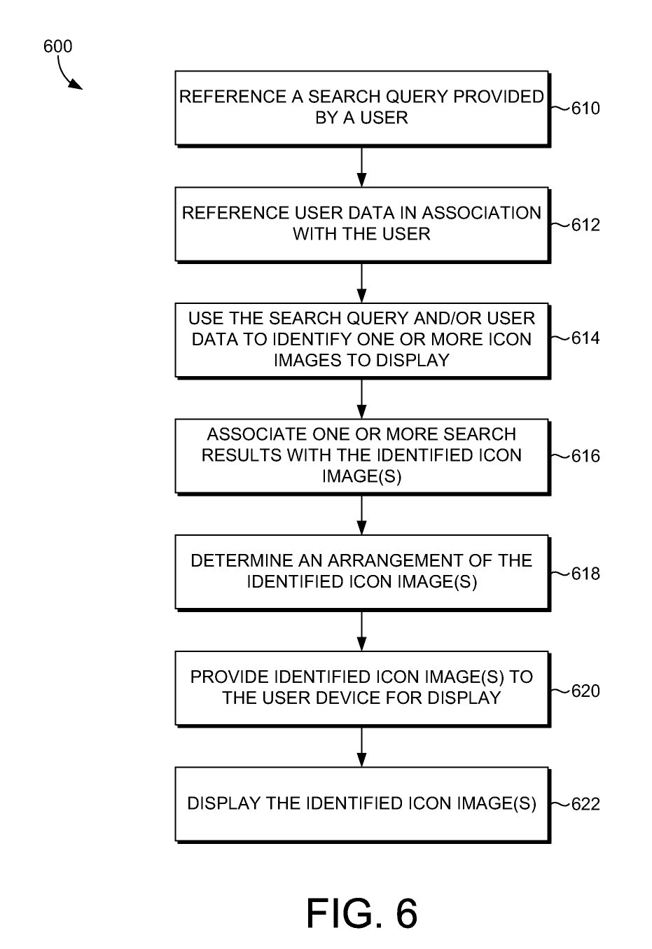

With reference to FIG. 6, a flow diagram is illustrated which shows a method 600 for presenting one or more icon images customized for a user, in accordance with an embodiment of the present invention. Initially, at block 610, a search query provided by a user is referenced. At block 612, user data in association with the user is referenced. Subsequently, at block 614, the search query and/or the user data are used to identify one or more icon images to display. In embodiments, the identified icon images correspond with and are suitable for display to the user as icon images of the search results page. Search results corresponding with the search query are associated with icon images. This is indicated at block 616. At block 618, an arrangement of the identified icon images is determined. Such an arrangement may include position relative to one another, position relative to the background image, position on the display screen, size of the icon image, etc. In embodiments, an arrangement of the identified icon images might be based on, for example, the quantity of search results associated with each icon image, user profile data (e.g., user interests), device data, etc. At block 620, the identified images, or representations thereof, are provided to the user device for display. Arrangement indicators can also be provided to the user device to provide an indication of an arrangement of one or more icon images. As can be appreciated, in other embodiments, such an arrangement determination can be made by the user computing device. At block 622, the identified icon image(s) are displayed via a display screen of the user device in accordance with the determined arrangement. In embodiments, the icon images are displayed in association with other search results or a background image(s).

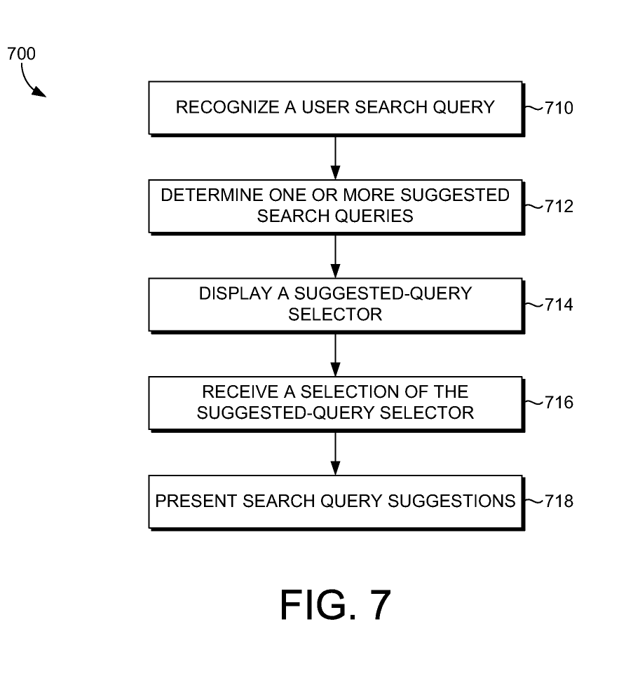

Turning now to FIG. 7, a flow diagram is illustrated which shows a method 700 for using a suggested-query selector to view alternative suggested search queries, in accordance with an embodiment of the present invention. Initially, as indicated at block 710, a user search query is recognized. The search query might be recognized based on a user inputting the query or upon entering the query (e.g., rolling). At block 712, one or more suggested search queries are determined. The suggested search queries might be identified or determined based on the entered data or the determined intent of the entered data. In embodiments, suggested search queries might also be identified based on various user data, such as user interests. At block 714, a suggested-query selector is displayed in association with a search experience (e.g., initially or upon performing the search). The suggested-query selector can provide an indication to the user that suggested queries exist. The suggested-query selector might be presented near the query entry or at any location. At block 716, a selection of the suggested-query selector is received. In accordance with the selection of the suggested-query selector, search query suggestions (e.g., additional or alternative) are presented to the user. This is indicated at block 718. Such query suggestions might be presented in a drop down list or any other list or formatting desired.

It will be understood by those of ordinary skill in the art that the order of steps shown in the method 500 of FIG. 5, method 600 of FIG. 6, and method 700 of FIG. 7 are not meant to limit the scope of the present invention in any way and, in fact, the steps may occur in a variety of different sequences within embodiments hereof. Any and all such variations, and any combination thereof, are contemplated to be within the scope of embodiments of the present invention.

The present invention has been described in relation to particular embodiments, which are intended in all respects to be illustrative rather than restrictive. Alternative embodiments will become apparent to those of ordinary skill in the art to which the present invention pertains without departing from its scope.

From the foregoing, it will be seen that this invention is one well adapted to attain all the ends and objects set forth above, together with other advantages which are obvious and inherent to the system and method. It will be understood that certain features and subcombinations are of utility and may be employed without reference to other features and subcombinations. This is contemplated by and is within the scope of the claims.

What is claimed is:

1. One or more computer storage media having computer-executable instructions embodied thereon, that when executed, cause a computing device to perform a method for presenting one or more background images customized for a user, the method comprising:
referencing a search query input by a user;
referencing one or more user data in association with the user;
utilizing the search query and the one or more user data in association with the user to select an image to display as a background image of a search results webpage; and
displaying the background image as a background of the search results webpage.

2. The media of claim 1, wherein the search query is input by the user via a mobile device.

3. The media of claim 1, wherein the one or more user data comprises at least one user profile data associated with an event, activity, or behavior of the user.

4. The media of claim 3, wherein the at least one user profile data comprises a routine search behavior of the user, a search or query previously provided by the user, a text or email conversation engaged in by the user, a multimedia event engaged in by the user, or a combination thereof.

5. The media of claim 1, wherein the one or more user data comprises at least one device data associated with a computing device being used by the user.

6. The media of claim 5, wherein the at least one device data comprises an indication of whether the computing device is touch enabled, an indication of a screen size of the device, a device identifier, an indication of available bandwidth for transferring data, or a combination thereof.

7. The media of claim 1, wherein the one or more user data comprises at least one relational data associated with another user that is related to the user.

8. The media of claim 7, wherein the another user is related to the user based on a contact with the user, a similar interest shared with the user, or a combination thereof.

9. The media of claim 1, wherein the one or more user data comprises at least one global data associated with one or more users of a search engine.

10. The media of claim 9, wherein the at least one global data comprises a most popular image, a most frequently used image, a preferred image, or a combination thereof.

11. The media of claim 1, wherein the search query is used to identify a plurality of images related to the search query and the one or more user data is used to select the image to display from the identified plurality of images related to the search query.

12. The media of claim 1, wherein the background image is displayed in association with a set of search results, or representations thereof.

13. A method for presenting icon images customized for a user, the method comprising:
referencing a search query input by a user;
referencing one or more user data in association with the user;
identifying one or more icon images to display based on the search query and the one or more user data in association with the user, each of the one or more icon images representing a category of search results; and
displaying the one or more icon images within a search results webpage, wherein selection of an icon image results in display of one or more search results, or information in association therewith, that correspond with the category of search results represented by the selected icon image.

14. The method of claim 13 further comprising associating search results related to the search query with the appropriate one or more icon images.

15. The method of claim 14 further comprising determining an arrangement for displaying the one or more icon images relative to one another.

16. The method of claim 15, wherein the arrangement is based on the user data or a quantity of search results related to each of the one or more icon images.

17. The method of claim 13 wherein the one or more user data comprises one or more user profile data, one or more device data, one or more relational data, one or more global data, or a combination thereof.

18. A system for customizing a search experience for a user, comprising:
a computing device associated with one or more processors and one or more computer-readable storage media;
a data store coupled with the computing device; and
an image selecting engine that
(1) receives a search query input by a user, user profile data that indicates at least one interest of the user, and device data in association with the computing device being used by the user,
(2) uses the search query, the user profile data, and the device data to identify a background image to be displayed as a background of a search results webpage and identify one or more icon images to be displayed on the search results webpage, the one or more icon images representing categories of search results, and
(3) outputs the background image and the one or more icon images for presentation.

19. The system of claim 18, wherein the image selecting engine determines an arrangement or position in which to place the one or more icon images based on the user profile data.

20. The system of claim 18, wherein the one or more icon images are positioned over the background image.
